(19) United States
(12) Patent Application Publication
(10) Pub. No.: US 2017/0118707 A1
(43) Pub. Date: Apr. 27, 2017

(54) TECHNIQUES FOR ACHIEVING OPTIMAL POWER AND MEAN OPINION SCORES FOR INTERNET PROTOCOL MULTIMEDIA SUBSYSTEM-BASED DUAL CONNECTIVITY CALLING

(71) Applicant: QUALCOMM Incorporated, San Diego, CA (US)

(72) Inventors: Murali Bharadwaj, San Diego, CA (US); Vikram Singh, San Diego, CA (US); Chinmay Dhodapkar, San Diego, CA (US)

(21) Appl. No.: 15/265,822

(22) Filed: Sep. 14, 2016

Related U.S. Application Data
(60) Provisional application No. 62/244,646, filed on Oct. 21, 2015.

(51) Int. Cl. H04W 52/02; H04L 29/08; H04L 29/06

(52) U.S. Cl. CPC H04W 52/028; H04L 65/1096; H04L 67/303; H04W 84/12

(57) ABSTRACT

Techniques are described for wireless communication. One method includes determining at a first time that a voice call is routed over a wireless local area network (WLAN); restricting an application processor from entering a first sleep state based at least in part on determining that the voice call is routed over the WLAN; determining at a second time that the voice call is offloaded from the WLAN to a wireless wide area network (WWAN); and enabling the application processor to enter a second sleep state based at least in part on determining that the voice call is routed over the WWAN.

### CROSS REFERENCES

The present application for patent claims priority to U.S. Provisional Patent Application No. 62/244,646 by Bharadwaj, et al., entitled “Techniques For Restricting And Enabling An Application Processor To Enter A Sleep State During A Voice Call,” filed Oct. 21, 2015, assigned to the assignee hereof, which is hereby incorporated by reference in its entirety.

### BACKGROUND

Field of the Disclosure

The present disclosure, for example, relates to wireless communication systems, and more particularly to techniques for restricting and enabling an application processor to enter a sleep state during a voice call.

Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipment (UE) devices. A base station may communicate with UEs on downlink channels (e.g., for transmissions from a base station to a UE) and uplink channels (e.g., for transmissions from a UE to a base station).

One form of communication between a UE and a base station is a voice call. A voice call may be established as a packet-switched voice call or a circuit-switched voice call. When established as a packet-switched voice call, a voice call may be established as an Internet Protocol (IP) Multimedia Subsystem (IMS)-based voice call. A type of IMS-based voice call carried over a wireless wide area network (e.g., a WWAN, such as a Long Term Evolution (LTE) or LTE-Advanced (LTE-A) network) is a Voice over LTE (VoLTE) call. A type of IMS-based voice call carried over a wireless local area network (WLAN) is a Wi-Fi calling (WFC) call.

### SUMMARY

The present disclosure relates to techniques for achieving optimal power and mean opinion score (MOS) for IMS based dual connectivity calling. In some examples, a determination may be made about whether a voice call processed by a modem is routed over a WWAN (e.g., as a VoLTE call, a LTE/LTE-A call, a 3G call, or a 2G call) or a WLAN (e.g., as a WFC call). In some examples, the determination may be made during (or as part of) an IMS call setup procedure in which an application processor that processes voice call traffic routed over the WLAN participates when initiating the voice call (or when participating in a handover of the voice call, such as a handover to or from being routed over the WLAN). The application processor, in some examples, may be restricted from entering a sleep state based on determining the voice call processed by the modem is routed over the WLAN. A sleep state may include, but is not limited to, a deep sleep state or a light sleep state. In some examples, the application processor may enter a light sleep state at periods, when the voice call processed by the modem is routed over the WLAN. Alternatively, the application processor may be enabled to enter a deep sleep state when the voice call processed by the modem is routed over the WWAN. Additionally, the UE may calculate a MOS for the voice call processed by the modem. The MOS may be calculated when the application processor is restricted from entering the deep sleep state (e.g., when the voice call processed by the modem is routed over the WLAN) or when the application processor is enabled to enter the deep sleep state (e.g., when the voice call processed by the modem is routed over the WWAN).

In one example, a method for wireless communication is described. The method may include determining at a first time that a voice call is routed over a WLAN; restricting an application processor from entering a first sleep state based at least in part on determining that the voice call is routed over the WLAN; determining at a second time that the voice call is offloaded from the WLAN to a WWAN; and enabling the application processor to enter a second sleep state based at least in part on determining that the voice call is routed over the WWAN.

In some examples, the first time occurs before the second time. In some examples, the method may include calculating a mean opinion score (MOS) associated with the voice call received by a modem based at least in part on restricting the application processor from entering the first sleep state, or enabling the application processor to enter the second sleep state, or a combination thereof. In some examples, the method may include maintaining a power profile associated with an interface of the modem based at least in part on the calculated MOS. In some examples, the method may include adjusting a power profile associated with an interface of the modem based at least in part on the calculated MOS.

In some examples, the method may include determining a display state of a user equipment (UE). In some example of the method, calculating the MOS associated with the voice call is based at least in part on determining the UE is connected to the external power source. In some examples, the method may include determining whether a UE is connected to an external power source. In some examples of the method, calculating the MOS associated with the voice call is based at least in part on determining the UE is connected to the external power source.

In some examples of the method, the first sleep state is the same as the second sleep state. In some examples, the first sleep state comprises a state that reduces a power consumption of a modem based at least in part on a packet exchange associated with the voice call over the WLAN. In some examples of the method, the second sleep state comprises a state that reduces a power consumption of a modem during a duration associated with the voice call over the WWAN. In some examples, the method may include identifying a location of a UE associated with the voice call. In some examples of the method, determining that the voice call received by a modem is routed over the WLAN or the WWAN is based at least in part on the identification.

In some examples, an apparatus for wireless communication is described. The apparatus may include a processor, and memory in electronic communication with the processor. The processor and the memory may be configured to determine at a first time that a voice call is routed over a WLAN; restrict an application processor from entering a first sleep state based at least in part on determining that the voice call is routed over the WLAN; determine at a second time that the voice call is offloaded from the WLAN to a WWAN; and enable the application processor to enter a second sleep state based at least in part on determining that the voice call is routed over the WWAN.

In some examples of the apparatus, the first time occurs before the second time. In some examples of the apparatus, the processor and the memory may be configured to calculate a mean opinion score (MOS) associated with the voice call received by a modem based at least in part on restricting the application processor from entering the first sleep state, or enabling the application processor to enter the second sleep state, or a combination thereof. The processor and the memory may be configured to maintain a power profile associated with an interface of the modem based at least in part on the calculated MOS. In some examples of the apparatus, the processor and the memory may be configured to adjust a power profile associated with an interface of the modem based at least in part on the calculated MOS. In some examples, the interface may comprise a WWAN interface or a WLAN interface.

In some examples of the apparatus, the processor and the memory may be configured to determine a display state of a user equipment (UE). The processor and the memory may be configured to, in some examples, calculate the MOS associated with the voice call is based at least in part on determining the display state. In some examples of the apparatus, the processor and the memory may be configured to determine whether a UE is connected to an external power source. The processor and the memory may be configured to, in some examples, calculate the MOS associated with the voice call is based at least in part on determining the UE is connected to the external power source.

In some examples of the apparatus, the first sleep state is the same as the second sleep state. In some examples of the apparatus, the first sleep state comprises a state that reduces a power consumption of a modem based at least in part on a packet exchange associated with the voice call over the WLAN. In some examples of the apparatus, the second sleep state comprises a state that reduces a power consumption of a modem during a duration associated with the voice call over the WWAN. In some examples of the apparatus, the processor and the memory may be configured to identify a location of a UE associated with the voice call. The processor and the memory may be configured to, in some examples, determine that the voice call received by a modem is routed over the WLAN or the WWAN is based at least in part on the identification.

In some examples, another apparatus for wireless communication is described. The apparatus may include means for determining at a first time that a voice call is routed over a wireless local area network (WLAN); means for restricting an application processor from entering a first sleep state based at least in part on determining that the voice call is routed over the WLAN; means for determining at a second time that the voice call is offloaded from the WLAN to a wireless wide area network (WWAN); and means for enabling the application processor to enter a second sleep state based at least in part on determining that the voice call is routed over the WWAN.

In some examples of the apparatus, the first time occurs before the second time. In some examples, the apparatus may include means for calculating a mean opinion score (MOS) associated with the voice call received by a modem based at least in part on restricting the application processor from entering the first sleep state, or enabling the application processor to enter the second sleep state, or a combination thereof. The apparatus, in some examples, may include means for maintaining a power profile associated with an interface of the modem based at least in part on the calculated MOS. In some examples, the apparatus may include adjusting a power profile associated with an interface of the modem based at least in part on the calculated MOS. In some examples of the apparatus, the interface comprises a WWAN interface or a WLAN interface.

In some examples, the apparatus may include means for determining a display state of a user equipment (UE). In some examples of the apparatus, the means for calculating the MOS associated with the voice call is based at least in part on determining the display state. In some examples, the apparatus may include means for determining whether a UE is connected to an external power source. In some examples of the apparatus, the means for calculating the MOS associated with the voice call is based at least in part on determining the UE is connected to the external power source.

In some examples of the apparatus, the first sleep state is the same as the second sleep state. In some examples of the apparatus, the first sleep state comprises a state that reduces a power consumption of a modem based at least in part on a packet exchange associated with the voice call over the WLAN. In some examples of the apparatus, the second sleep state comprises a state that reduces a power consumption of a modem during a duration associated with the voice call over the WWAN. In some examples, the apparatus may include identifying a location of a UE associated with the voice call. In some examples of the apparatus, the means for determining that the voice call received by a modem is routed over the WLAN or the WWAN is based at least in part on the identification.

In some examples, a non-transitory computer-readable medium storing computer-executable code for wireless communication is described. The code may be executable by a processor to determine at a first time that a voice call is routed over a wireless local area network (WLAN); restrict an application processor from entering a first sleep state based at least in part on determining that the voice call is routed over the WLAN; determine at a second time that the voice call is offloaded from the WLAN to a wireless wide area network (WWAN); and enable the application processor to enter a second sleep state based at least in part on determining that the voice call is routed over the WWAN.

In some examples of the non-transitory computer-readable medium, the first time occurs before the second time. In some examples, the code may be executable by the processor to calculate a mean opinion score (MOS) associated with the voice call received by a modem based at least in part on restricting the application processor from entering the first sleep state, or enabling the application processor to enter the second sleep state, or a combination thereof. In some examples, the code may be executable by the processor to maintain a power profile associated with an interface of the modem based at least in part on the calculated MOS. In some examples, the code may be executable by the processor to adjust a power profile associated with an interface of the modem based at least in part on the calculated MOS. In some examples of the non-transitory computer-readable medium, the interface comprises a WWAN interface or a WLAN interface.

In some examples, the code may be executable by the processor to determine a display state of a user equipment (UE). In some examples of the non-transitory computer-readable medium, the code may be executable by the processor to calculate the MOS associated with the voice call is based at least in part on determining the display state. In some examples, the code may be executable by the processor to determining whether a UE is connected to an external power source. In some examples of the non-transitory computer-readable medium, the code may be executable by the processor to calculate the MOS associated with the voice call is based at least in part on determining the UE is connected to the external power source.

In some examples of the non-transitory computer-readable medium, the first sleep state is the same as the second sleep state. In some examples of the non-transitory computer-readable medium, the first sleep state comprises a state that reduces a power consumption of a modem based at least in part on a packet exchange associated with the voice call over the WLAN. In some examples of the non-transitory computer-readable medium, the second sleep state comprises a state that reduces a power consumption of a modem during a duration associated with the voice call over the WWAN. In some examples, the code may be executable by the processor to identify a location of a UE associated with the voice call. In some examples of the non-transitory computer-readable medium, the code may be executable by the processor to determine that the voice call received by a modem is routed over the WLAN or the WWAN is based at least in part on the identification.

The foregoing has outlined rather broadly the techniques and technical advantages of examples according to the disclosure in order that the detailed description that follows may be better understood. Additional techniques and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present invention may be realized by reference to the following drawings. In the appended figures, similar components or functions may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system, in accordance with various aspects of the present disclosure;

FIG. 2 illustrates an example of a wireless communication system, in accordance with various aspects of the present disclosure;

FIG. 3 shows a block diagram of an apparatus for use in wireless communication, in accordance with various aspects of the present disclosure;

FIG. 4 shows a block diagram of an apparatus for use in wireless communication, in accordance with various aspects of the present disclosure;

FIG. 5 shows a block diagram of a UE for use in wireless communication, in accordance with various aspects of the present disclosure;

FIG. 6 is a flow chart illustrating an example of a method for wireless communication, in accordance with various aspects of the present disclosure;

FIG. 7 is a flow chart illustrating an example of a method for wireless communication, in accordance with various aspects of the present disclosure; and

FIG. 8 is a flow chart illustrating an example of a method for wireless communication, in accordance with various aspects of the present disclosure.

### DETAILED DESCRIPTION

Techniques are described for restricting and enabling an application processor to enter a sleep state during a voice call. IMS-based LTE calling (e.g., VoLTE calling) and Wi-Fi calling (e.g., WFC calling) are transforming mobile-based voice calling. VoLTE and single radio voice call continuity (SRVCC) handovers (e.g., LTE/LTE-A to Wi-Fi or LTE/LTE-A to Global System for Mobile Communications (GSM) inter-radio access technology handovers) have been deployed with multiple optimizations in the Internet Protocol (IP) Multimedia System (IMS), modem lower layers (e.g., LTE/LTE-A, Multimode, Data, Radio Resource Control (RRC), and Non-Access Stratum (NAS) layers), audio digital signal processing, and in Google® Android® systems (e.g., telephony and Radio Interface Layer (RIL)). Given these advances, LTE/LTE-A and Wi-Fi coexistence for voice calls, and handovers of voice calls, needs to be addressed, with respect to power management and voice call performance at a UE participating in an IMS-based voice call.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

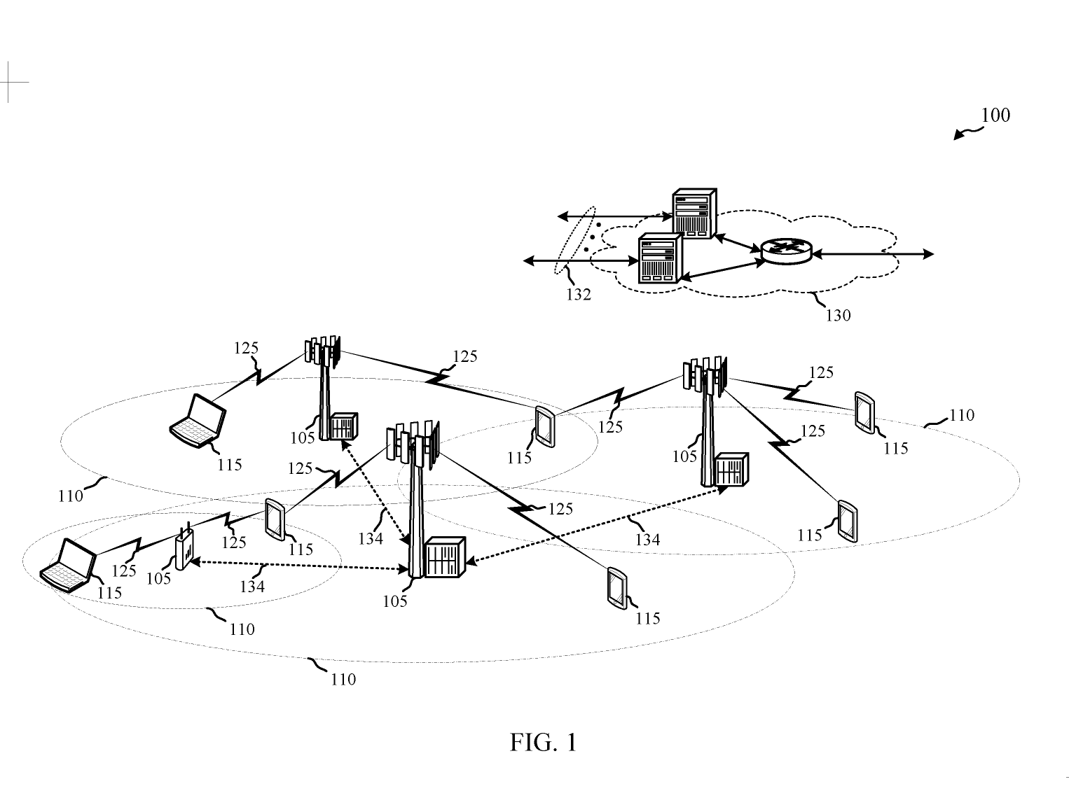

FIG. 1 illustrates an example of a wireless communication system 100, in accordance with various aspects of the present disclosure. The wireless communication system 100 may include base stations 105, UEs 115, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, a base station 105 may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105 may be divided into sectors making up a portion of the coverage area (not shown). The wireless communication system 100 may include base stations 105 of different types (e.g., macro or small cell base stations). In some examples, geographic coverage area 110 may include an overlapping geographic coverage area for different technologies.

In some examples, the wireless communication system 100 may include an LTE/LTE-A network. In LTE/LTE-A networks, the term evolved Node B (eNB) may be used to describe a base station 105, while the term UE may be used to describe a UE 115. The wireless communication system 100 may be a Heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., licensed, shared, etc.) radio frequency spectrum bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

In some examples, the wireless communication system 100 may include a WLAN. In a WLAN, the term access point (AP) may be used to describe a base station 105, while the term station (STA) may be used to describe the UEs 115.

The wireless communication system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the RRC protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment, including macro eNBs, small cell eNBs, relay base stations, and the like.

The communication link(s) 125 shown in wireless communication system 100 may include downlink (DL) transmissions, from a base station 105 to a UE 115, or uplink (UL) transmissions, from a UE 115 to a base station 105. The downlink transmissions may also be called forward link transmissions, while the uplink transmissions may also be called reverse link transmissions.

In some examples, each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication link(s) 125 may transmit bidirectional communications using a frequency domain duplexing (FDD) operation (e.g., using paired spectrum resources) or a time domain duplexing (TDD) operation (e.g., using unpaired spectrum resources). Frame structures for FDD operation (e.g., frame structure type 1) and TDD operation (e.g., frame structure type 2) may be defined.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input, multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or dual-connectivity operation. A carrier may also be referred to as a component carrier (CC), a layer, a channel, etc. The terms “carrier,” “component carrier,” “cell,” and “channel” may be used interchangeably herein. Carrier aggregation may be used with both FDD and TDD component carriers.

As a UE 115 moves within the wireless communication system 100, the UE 115 may be handed over from one base station 105 to another base station 105. In some cases, a UE 115 may be handed over from a base station 105 operating according to one radio access technology (RAT) to a base station 105 operating according to another RAT. During the course of a voice call placed to or from a UE 115, the UE 115 may be handed over one or many times. A wireless device, for example, UE 115 may determine whether a voice call is routed over a WLAN or a WWAN. The present disclosure describes techniques for restricting an application processor from entering a sleep state or enabling an application processor to enter a sleep state based at least in part on determining the a voice call is routed over a WLAN or a WWAN.

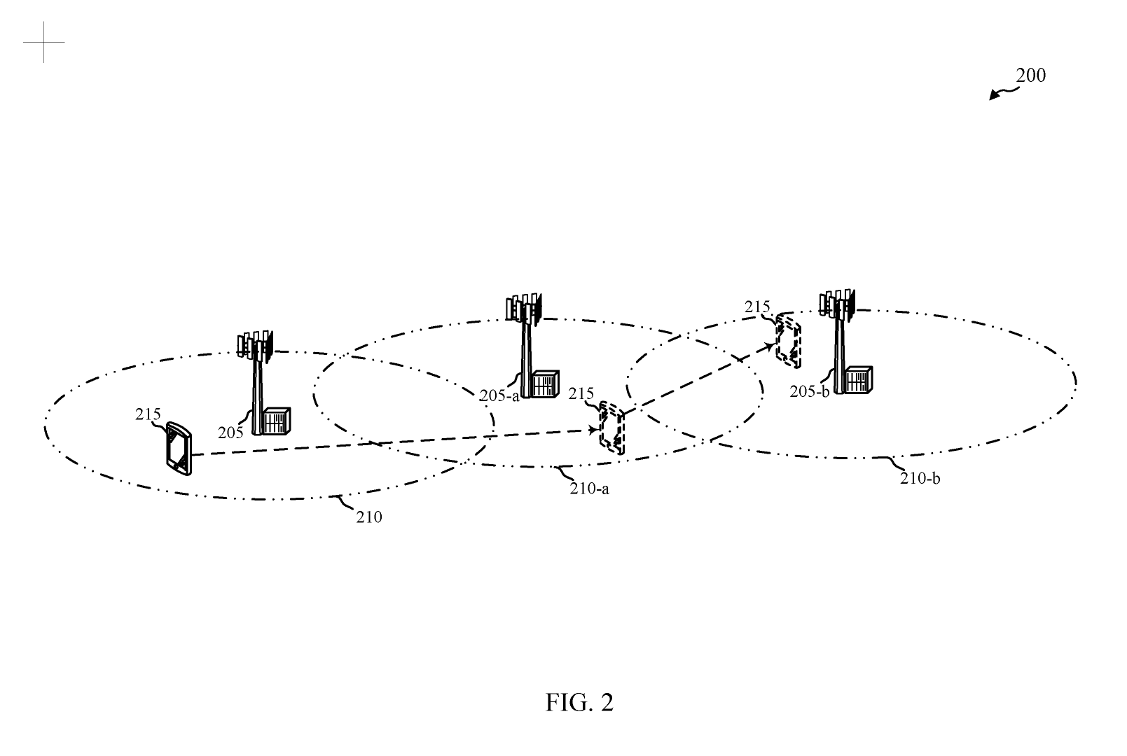

FIG. 2 illustrates an example of a wireless communication system 200, in accordance with various aspects of the present disclosure. The wireless communication system 200 may be an example of a portion of the wireless communication system 100 and may include a first base station 205, a second base station 205-a, a third base station 205-b, and a UE 215. The first base station 205, second base station 205-a, third base station 205-b, and UE 215 may be examples of the base stations 105 or UEs 115 described with reference to FIG. 1.

As shown in FIG. 2, the UE 215 may move from a first coverage area 210 of the first base station, to a second coverage area 210-a of the second base station 205-a, to a third coverage area 210-b of the third base station 205-b. As the UE 215 moves from coverage area to coverage area, the UE 215 may be handed over from base station to base station.

In one example, the first base station 205 may be a first WLAN access point associated with a first WLAN, the second base station 205-a may be an eNB associated with a LTE/LTE-A network, and the third base station 205-b may be a WLAN access point associated with a second WLAN. By way of example, the UE 215 may initiate a voice call while in the first coverage area 210 of the first base station 205. In one example, the UE 215 while in the first coverage area 210 may determine that the voice call is routed over a WLAN. In some examples, the UE 215 may determine that the voice call is routed over a WLAN at a first time. In some examples, the UE 215 may determine that the voice call is routed over a WLAN based at least in part on information received in a frame (e.g., beacon frame) from another device (e.g., first base station 205). The UE 215, in some examples, may restrict an application processor of UE 215 from entering a sleep state based at least in part on determining that the voice call is routed over the WLAN.

In some examples, the voice call may be initially served by the first base station 205, but may be subsequently handed over to the second base station 205-a (e.g., when the UE 215 enters the second coverage area 210-a of the second base station 205-a and associates with the second base station 205-a), and may be subsequently handed over to the third base station 205-b (e.g., when the UE 215 enters the third coverage area 210-b of the third base station 205-b and associates with the third base station 205-b). In one example, the UE 215, while in the second coverage area 210-a of the second base station 205-a, may determine that voice call is offloaded from the WLAN to a WWAN. In some examples, the UE 215, while in the second coverage area 210-a of the second base station 205-a, may determine at a second time after a first time that the voice call is offloaded from the WLAN to a WWAN. In some examples, the UE 215 may determine that the voice call is offloaded from the WLAN to a WWAN based at least in part on information received in a frame (e.g., beacon frame) from another device (e.g., second base station 205-a). The UE 215, in some examples, may enable an application processor of UE 215 to enter a sleep state based at least in part on determining that the voice call is routed over the WWAN.

In some examples, when associated with each of the base stations, the UE 215 may calculate a mean opinion score (MOS). In some examples, the calculated MOS is based at least in part on analyzing MOS parameters such as, quality of service (QoS) factors, latency, packet loss, jitter, etc., during a voice call. In some example, when associated with a base station, the UE 215 may calculate a MOS associated with a voice call based at least in part restricting an application processor from entering a first sleep state, or enabling the application processor to enter a second sleep state, or a combination thereof. In one example, a first sleep state or a second sleep state may correlate with a MOS parameter during a voice call. For example, a first sleep state may include a state that reduces a power consumption of a modem based at least in part on a packet exchange associated with a voice call over a WLAN. In some examples, a second sleep state may include a state that reduces a power consumption of a modem during a duration associated with the voice call over the WWAN. In some examples, the duration may be a period during the voice call that has a minimum impact on one or more MOS parameters. For example, the duration may include a period where the UE 215 is not transmitting data packets to a base station or receiving data packets from a base station (e.g., third base station 205-b).

In some examples, the UE 215 may maintain a power profile for an interface of the UE based at least in part on the calculated MOS. In one example, the UE may maintain or adjust a power profile for an interface of the UE (e.g., an interface, such as a WWAN interface or a WLAN interface), used to communicate with a respective one of the first base station 205, the second base station 205-a, or the third base station 205-b based at least in part on a calculated MOS.

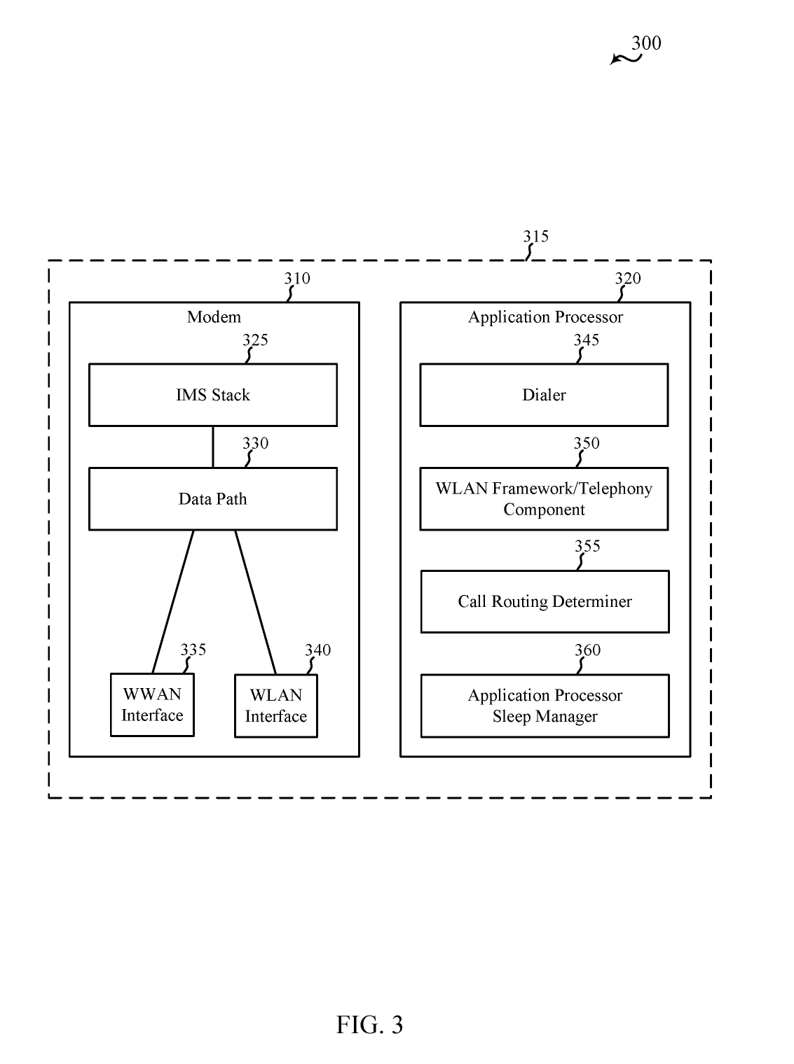

FIG. 3 shows a block diagram 300 of an apparatus 315 for use in wireless communication, in accordance with various aspects of the present disclosure. The apparatus 315 may be an example of aspects of one or more of the UEs 115 or 215 described with reference to FIG. 1 or 2. The apparatus 315 may also be or include a processor (e.g., a digital signal processor (DSP)). The apparatus 315 may include a modem 310 or an application processor 320. Each of these components may be in communication with each other.

The components of the apparatus 315 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), a System-on-Chip (SoC), and/or other types of Semi-Custom ICs), which may be programmed in any manner known in the art. The functions of each component may also be implemented, in whole or in part, with instructions embodied in a memory, formatted to be executed by one or more general or application-specific processors.

In some examples, the modem 310 may be a multimode and may include an IMS stack 325, a data path 330, a WWAN interface 335 (e.g., a LTE/LTE-A interface), or a WLAN interface 340 (e.g., a Wi-Fi interface). In some examples, the application processor 320 may include a dialer 345, a WLAN framework/telephony component 350, a call routing determiner 355, or an application processor sleep manager 360.

The processing (e.g., routing/handling) of voice calls, including control signals (signaling) and audio associated with voice calls, may be centralized within the modem 310. Data pertaining to voice calls initiated by a WWAN chipset (not shown), or data pertaining to portions of voice calls processed by the WWAN chipset, may be transferred from the WWAN chipset to the IMS stack 325, in a downlink direction (or vice versa, in an uplink direction), and from the IMS stack 325 to the WWAN interface 335 (or vice versa) via the data path 330. The WWAN data may be transmitted over, or received over, a WWAN through the WWAN interface 335 (e.g., as a VoLTE call). Data pertaining to voice calls initiated by a WLAN chipset (not shown), or data pertaining to portions of voice calls processed by the WLAN chipset, may be transferred from the WLAN chipset to the dialer 345 or WLAN framework/telephony component 350, in downlink direction (or vice versa, in an uplink direction), from the dialer 345 or WLAN framework/telephony component 350 to the WLAN interface 340 (or vice versa) via the data path 330 (e.g., via surface mount device (SMD) between the modem 310 and the application processor 320). WLAN data may be transmitted over, or received over, a WLAN through the WLAN interface 340 (e.g., as a WFC call).

In some examples, when a voice call, or portions of the voice call, are transmitted or received over a WWAN (e.g., as an IMS-based call (e.g., a VoLTE call), the application processor 320 may be enabled to enter a second sleep state. In one example, the second sleep state may be a deep sleep state that reduces a power consumption of the modem 310 to a level during a duration associated with the voice call over the WWAN. In some examples, when a voice call, or portions of the voice call are handed over to a circuit-switched network (e.g., handed over using dual radio voice call continuity (DRVCC) procedures as a 3G call or 2G call)), the application processor 320 may be enabled to enter the second sleep state. In some examples, the apparatus 315 may calculate a MOS for the voice call or the portions of the voice call transmitted or received over the WWAN. The modem 310, in one example, may maintain or adjust a power profile of the WWAN interface 335 based at least in part on the calculated MOS.

Alternatively, when a voice call, or portions of the voice call, are transmitted or received over a WLAN, the application processor 320 may be restricted from entering the second sleep state. In some examples, restricting the application processor 320 may enable the application processor 320 to decrease voice call processing delays. In one example, decreasing voice call processing delays allows the apparatus 315 to improve accuracy in calculating a MOS for the portions of the voice call transmitted or received over the WLAN. The modem 310, in some examples, may maintain or adjust a power profile of the WLAN interface 340 based at least in part on the calculated MOS. In some examples, restricting the application processor 320 from entering the second sleep state between portions of WLAN call processing can also decrease a power consumption of the apparatus 315.

In some examples, despite restricting the application processor 320 from entering the second sleep state when a voice call, or portions of the voice call, are transmitted or received over a WLAN, the application processor 320 may be allowed to enter a first sleep state between portions of WLAN call processing (e.g., between signaling and audio packet exchange, or between 20 millisecond audio packet exchanges on both uplink and downlink). In one example, the first sleep state may be a light sleep state. In some examples, the first sleep state may include a state that reduces a power consumption of a modem to a level based at least in part on a packet exchange associated with the voice call over the WLAN.

In some examples, the call routing determiner 355 may determine whether a voice call is routed over a WWAN or a WLAN. In one example, based at least in part on the call routing determiner 355 may determine that a voice call is routed over the WWAN or the WLAN, and transmit an indication to the application processor sleep manager 360. The indication may include, but is not limited to, information indicative to the application processor sleep manager 360 that a voce call is routed over a WWAN or a WLAN. In some examples, the application processor sleep manager 360 may restrict the application processor 320 from entering a first sleep state, or to enable the application processor 320 to enter a second sleep state based at least in part on the received indication. In one example, the second sleep state may be a deep sleep state. In some examples, the second sleep state may comprise a state that reduces a power consumption of a modem during a duration associated with the voice call over the WWAN. In some examples, the call routing determiner 355 may be provided by a RIL, such as the Google® Android® RIL. In some examples, the application processor sleep manager 360 may be a power manager such as the Google® Android® WakeLock power manager.

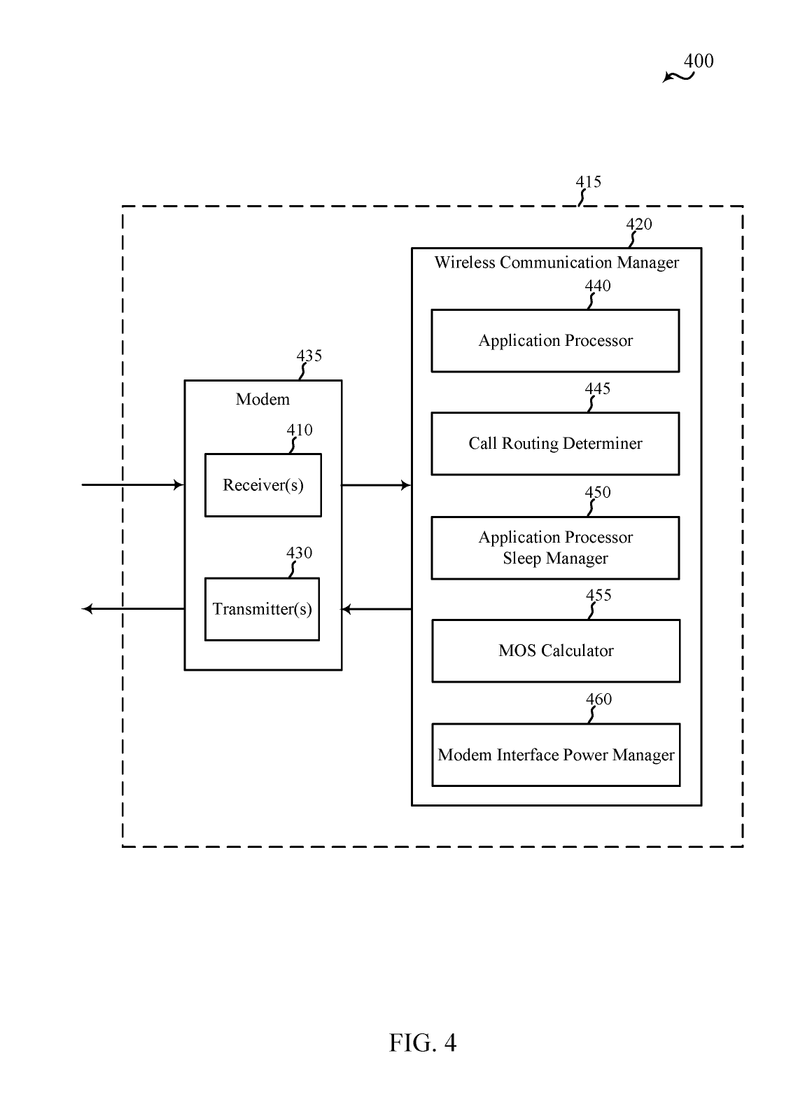

FIG. 4 shows a block diagram 400 of an apparatus 415 for use in wireless communication, in accordance with various aspects of the present disclosure. The apparatus 415 may be an example of aspects of one or more of the UEs 115 or 215 described with reference to FIG. 1 or 2, or aspects of the apparatus 315 described with reference to FIG. 3. The apparatus 415 may also be or include a processor (e.g., a DSP). The apparatus 415 may include a number of receivers (represented as receiver(s) 410), a wireless communication manager 420, or a number of transmitters (represented as transmitter(s) 430). Each of these components may be in communication with each other.

The components of the apparatus 415 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, a SoC, and/or other types of Semi-Custom ICs), which may be programmed in any manner known in the art. The functions of each component may also be implemented, in whole or in part, with instructions embodied in a memory, formatted to be executed by one or more general or application-specific processors.

In some examples, the receiver(s) 410 may include a number of radio frequency (RF) receivers, such as a first RF receiver operable to receive transmissions over a WWAN, and a second RF receiver operable to receive transmissions over a WLAN, as described, for example, with reference to FIG. 1, 2, or 3. The receiver 410 may be used to receive various types of audio or control signals (i.e., transmissions) pertaining to voice calls, which voice calls may be routed over one or more packet-switched communication links or circuit-switched communication links of a wireless communication system (e.g., over one or more communication links of the wireless communication system 100 or 200 described with reference to FIG. 1 or 2).

In some examples, the transmitter(s) 430 may include a number of RF transmitters, such as a first RF transmitter operable to transmit over a WWAN, and a second RF receiver operable to transmit over a WLAN, as described, for example, with reference to FIG. 1, 2, or 3. The transmitter(s) 430 may be used to transmit various types of audio or control signals (i.e., transmissions) pertaining to voice calls, which voice calls may be routed over one or more packet-switched communication links or circuit-switched communication links of a wireless communication system (e.g., over one or more communication links of the wireless communication system 100 or 200 described with reference to FIG. 1 or 2).

Some or all of the receiver(s) 410 and transmitter(s) 430 may be provided by a modem 435. In some examples, the modem 435 may provide some or all of the receiver(s) 410 and transmitter(s) 430 as part of a WWAN interface supporting LTE/LTE-A, 3G, 2G, and/or other communications over a WWAN, and a WLAN interface supporting WFC and/or or other communications over a WLAN. In some examples, the modem 435 may be an example of the modem 310 described with reference to FIG. 3.

In some examples, the wireless communication manager 420 may be used to manage one or more aspects of wireless communication for the apparatus 415. In some examples, part of the wireless communication manager 420 may be incorporated into or shared with the receiver(s) 410, the transmitter(s) 430, or the modem 435. In some examples, the wireless communication manager 420 may include an application processor 440, a call routing determiner 445, an application processor sleep manager 450, an optional MOS calculator 455, or a modem interface power manager 460. In some examples, the call routing determiner 445, application processor sleep manager 450, MOS calculator 455, or modem interface power manager 460 may be provided as part of the modem 435 and/or application processor 440.

In one example, the application processor 440 may process voice call traffic routed over a WLAN. In some examples, the application processor 440 may process voice call traffic routed over a WWAN.

In some examples, the call routing determiner 445 may determine whether a voice call processed by the modem 435 is routed over a WWAN (e.g., as a VoLTE call, a LTE/LTE-A call, a 3G call, or a 2G call) or a WLAN (e.g., as a WFC call). In one example, the call routing determiner 445 may determine at a first time that a voice call is routed over a WLAN. In some examples, the call routing determiner 445 may determine at a second time that a voice call is routed over a WWAN. In some examples, the first time occurs before the second time. In some examples, the call routing determiner 445 may determine whether a voice call processed by the modem 435 is routed over a WWAN or a WLAN during (or as part of) an IMS call setup procedure in which the application processor 440 participates when initiating the voice call. Additionally or alternatively, the call routing determiner 445 may determine whether a voice call processed by the modem 435 is routed over a WWAN or a WLAN during a handover of the voice call, such as a handover to or from being routed over the WLAN or the WWAN.

In some examples, the application processor sleep manager 450 may restrict the application processor 440 from entering a first sleep state based at least in part on determining that the voice call processed by the modem 435 is routed over the WLAN. In some examples, the first sleep state may include a light sleep state. In some examples, the light sleep state may include reducing a power consumption of a modem based at least in part on a packet exchange associated with the voice call over the WLAN. The application processor 440 may enter the first sleep state, at times, when the voice call processed by the modem 435 is routed over the WWAN.

In some examples, the application processor sleep manager 450 may enable the application processor 440 to enter a second sleep state when the voice call processed by the modem 435 is routed over the WWAN. In some examples, the second sleep state may include a deep sleep state. The deep sleep state may include, but is not limited to, a state that reduces a power consumption of a modem during a duration associated with the voice call over the WWAN. In an example, restricting the application processor 440 to enter a first sleep state may be performed, for example, when the voice call processed by the modem 435 is initially routed over WLAN, or handed over to the WLAN, as a WFC call. In some examples, enabling the application processor 440 to enter a second sleep state may be performed, for example, when the voice call processed by the modem 435 is initially routed over WWAN, or handed over to the WWAN, as a VoLTE call, a LTE/LTE-A call, a 3G call, or a 2G call.

The MOS calculator 455, in some examples, may calculate a MOS for a voice call processed by the modem 435. In some examples, the MOS calculator 455 may calculate a MOS for a voice call based at least in part on determining whether the voice call is routed over a WLAN or a WWAN. For example, the MOS calculator 455 may calculate a MOS when the application processor 440 is restricted from entering the first sleep state (e.g., when the voice call processed by the modem 435 is routed over the WLAN). Alternatively, the MOS calculator 455 may calculate a MOS when the application processor 440 is enabled to enter the second sleep state (e.g., when the voice call processed by the modem 435 is routed over the WWAN).

In some examples, the MOS calculator 455 may determine a display state associated with the apparatus 415. For example, a display state may include an OFF state. In some examples, the MOS calculator 455 may calculate a MOS based at least in part on the display state and a routing of a voice call, e.g., voice call routing over a WLAN or a WWAN. The MOS calculator 455, in some examples, may determine whether the apparatus 415 is connected to an external power source. In some examples, apparatus 415 may transmit a message including an indication that the apparatus 415 is connected to an external power source. For example, a message may be a beacon signal including a received signal strength indicator (RSSI). In some examples, the MOS calculator 455 may determine that the apparatus 415 is connected to an external power source based at least in part on receiving the message.

In some examples, the apparatus 415 may receive power from an external power source based at least in part on a physical USB interface (not shown). In some examples, the MOS calculator 415 may determine that the apparatus 415 is connected to an external power source based at least in part on a transmission power value associated with the apparatus 415. For example, the MOS calculator 455 may determine that the apparatus 415 transmits at a first power transmission value based at least in part on the apparatus 415 routing a voice call over a WLAN. In some examples, the MOS calculator 455 may determine that the apparatus 415 transmits at a second power transmission value based at least in part on the apparatus 415 routing a voice call over a WWAN. In some examples, the MOS calculator 455 may compare the first power transmission value, or the second power transmission value to a reference power transmission value. In some examples, if the first power transmission value or the second power transmission value is above or below the reference power transmission value may indicate to the MOS calculator 415 that the apparatus 415 is connected to an external power source.

In some examples, the MOS calculator 455 may calculate a MOS based at least in part on determining that the apparatus 415 is connected to the external power source and a routing of a voice call, e.g., voice call routing over a WLAN or a WWAN. In some examples, the MOS calculator 455 may calculate a MOS based at least in part on the display state, or whether the apparatus 415 is connected to an external power source, or a routing of a voice call, or a combination thereof.

The modem interface power manager 460, in some examples, may maintain or adjust a power profile of a WWAN interface or a WLAN interface of the modem 435, based at least in part on a calculated MOS by the MOS calculator 455. In some examples, the modem interface power manager 460 may adjust a power profile based at least in part on comparing a calculated MOS to a predetermined threshold MOS. In one example, a predetermined threshold MOS may include a MOS score or value. A MOS score may include, but is not limited to, a predetermined range. For example, a MOS score may have a range between two integer values, for example, 1 through 5. In some examples, a MOS score of a first value (e.g., value 1) may indicate that a quality of a received data packet (e.g., voice data) after being transmitted and compressed does not satisfy a predetermined threshold (e.g., is low, is unsatisfactory). Alternatively, a MOS score of a second value (e.g., value 5) may indicate that a quality of a received data packet (e.g., voice data) after being transmitted and compressed satisfies a predetermined threshold (e.g., is high, is satisfactory). Additionally or alternatively, in some examples, a power profile of the WWAN interface or the WLAN interface may be adjusted based at least in part on the calculated MOS differing from a MOS calculated earlier in time (or based at least in part on the calculated MOS differing from the earlier-calculated MOS by more than a threshold difference).

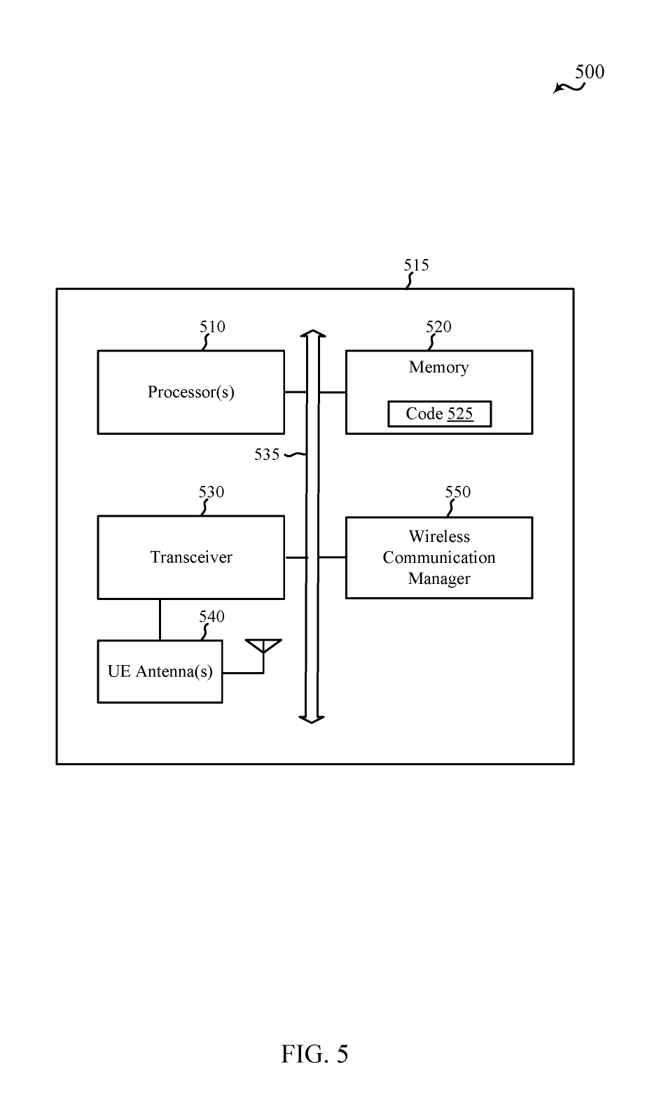

FIG. 5 shows a block diagram 500 of a UE 515 for use in wireless communication, in accordance with various aspects of the present disclosure. The UE 515 may be included or be part of a personal computer (e.g., a laptop computer, a netbook computer, a tablet computer, etc.), a cellular telephone, a smart phone, a PDA, a DVR, an internet appliance, a gaming console, an e-reader, etc. The UE 515 may, in some examples, have an internal power supply (not shown), such as a small battery, to facilitate mobile operation. In some examples, the UE 515 may be an example of aspects of one or more of the UEs 115 or 215 described with reference to FIG. 1 or 2, or aspects of the apparatus 315 or 415 described with reference to FIG. 3 or 4. The UE 515 may be configured to implement at least some of the UE or apparatus techniques and functions described with reference to FIG. 1, 2, 3, or 4.

The UE 515 may include at least one processor (represented by processor(s) 510), a memory 520, a transceiver 530, at least one antenna (represented by antenna(s) 540), or a wireless communication manager 550. Each of these components may be in communication with each other, directly or indirectly, over one or more buses 535.

The memory 520 may include random access memory (RAM) or read-only memory (ROM). The memory 520 may store computer-readable, computer-executable code 525 containing instructions that are configured to, when executed, cause the processor(s) 510 to perform various functions described herein related to wireless communication. Alternatively, the computer-executable code 525 may not be directly executable by the processor(s) 510 but be configured to cause the UE 515 (e.g., when compiled and executed) to perform various of the functions described herein.

The processor(s) 510 may include one or more intelligent hardware devices, e.g., a central processing unit (CPU), a microcontroller, an ASIC, etc. The processor(s) 510 may process information received through the transceiver 530 or information to be sent to the transceiver 530 for transmission through the UE antenna(s) 540. The processor(s) 510 may handle, alone or in connection with the wireless communication manager 550, various aspects of communicating over (or managing communications over) one or more radio frequency spectrum bands, including, for example, one or more radio frequency spectrum bands used by a WWAN and one or more radio frequency spectrum bands used by a WLAN. In some examples, the use of a radio frequency spectrum band may be shared by a WWAN and a WLAN. In some examples, the processor(s) 510 may include an application processor configured to process voice call traffic routed over a WLAN.

The transceiver 530 may include a modem configured to modulate packets and provide the modulated packets to the antenna(s) 540 for transmission. The modem may also demodulate packets received from the antenna(s) 540. In some examples, the modem may be an example of the modem 310 or 435 described with reference to FIG. 3 or 4. The transceiver 530 (or modem) may include, for example, a WWAN interface supporting LTE/LTE-A, 3G, 2G, and/or other communications over a WWAN, and a WLAN interface supporting WFC and/or or other communications over a WLAN. The transceiver 530 may be configured to communicate bi-directionally, via the antenna(s) 540, with one or more of the base station 105, 205, 205-a, or 205-b described with reference to FIG. 1 or 2. While the UE 515 may include a single antenna, there may be examples in which the UE 515 may include multiple antennas.

The wireless communication manager 550 may be configured to perform or control some or all of the UE or apparatus techniques or functions described with reference to FIG. 1, 2, 3, or 4 related to wireless communication over one or more radio frequency spectrum bands. The wireless communication manager 550, or portions of it, may include a processor (e.g., an application processor), or some or all of the functions of the wireless communication manager 550 may be performed by one or more of the processor(s) 510 or in connection with the processor(s) 510. In some examples, the wireless communication manager 550 may be an example of the wireless communication manager 420 described with reference to FIG. 4.

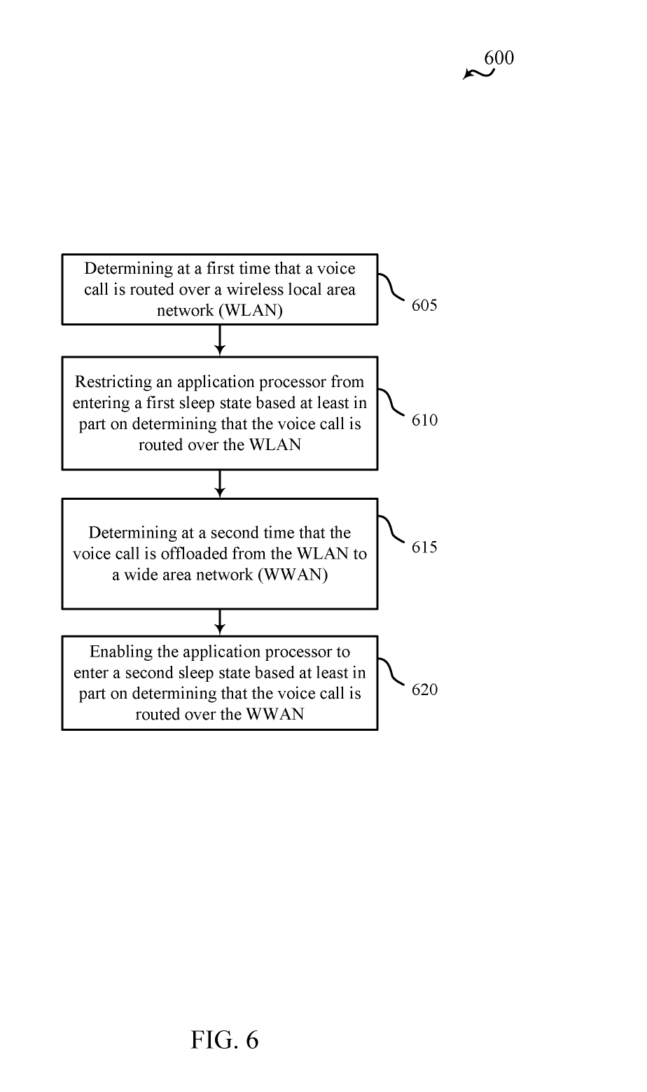

FIG. 6 is a flow chart illustrating an example of a method 600 for wireless communication, in accordance with various aspects of the present disclosure. For clarity, the method 600 is described below with reference to aspects of one or more of the UE 115, 215, or 515 described with reference to FIG. 1, 2, or 5, or aspects of the apparatus 315 or 415 described with reference to FIG. 3 or 4. In some examples, a UE may execute one or more sets of codes to control the functional elements of the UE to perform the functions described below. Additionally or alternatively, the UE may perform one or more of the functions described below using special-purpose hardware.

At block 605, the method 600 may include determining at a first time that a voice call is routed over a WLAN. In some examples, a voice call routed over a WLAN may include a WFC call. In some examples, determining at the first time that the voice call is routed over a WLAN may occur during (or as part of) an IMS call setup procedure in which an application processor that processes voice call traffic routed over the WLAN participates when initiating the voice call. Alternatively, in some examples, determining at the first time that the voice call is routed over a WLAN may occur when a UE participates in a handover of the voice call, such as a handover from routing the voice call over a WWAN to routing the voice call over the WLAN. The operation(s) at block 605 may be performed using the wireless communication manager 420 or 520 described with reference to FIG. 4 or 5, or the call routing determiner 445 described with reference to FIG. 4.

At block 610, the method 600 may include restricting an application processor from entering a first sleep state based at least in part on determining that the voice call is routed over the WLAN. In one example, the first sleep state may be a light sleep state. In some examples, the first sleep state may include a state that reduces a power consumption of a modem based at least in part on a packet exchange associated with the voice call over the WLAN. An application processor of a UE, for example, may enter a lighter sleep state, at times, when the voice call processed by a modem of the UE is routed over the WLAN. The operation(s) at block 610 may be performed using the wireless communication manager 420 or 550 described with reference to FIG. 4 or 5, or the application processor sleep manager 450 described with reference to FIG. 4.

At block 615, the method 600 may include determining at a second time that the voice call is offloaded from the WLAN to a WWAN. In some examples, a voice call routed over the WWAN may include a VoLTE call, a LTE/LTE-A call, a 3G call, or a 2G call. In some examples, determining at the second time that the voice call is routed over a WWAN may occur during (or as part of) an IMS call setup procedure in which an application processor that processes voice call traffic routed over the WWAN participates when initiating the voice call. Alternatively, in some examples, determining at the second time that the voice call is routed over a WWAN may occur when a UE participates in a handover of the voice call, such as a handover from routing the voice call over a WLAN to routing the voice call over the WWAN. The operation(s) at block 615 may be performed using the wireless communication manager 420 or 550 described with reference to FIG. 4 or 5, or the application processor sleep manager 450 described with reference to FIG. 4.

At block 620, the method 600 may include enabling the application processor to enter a second sleep state based at least in part on determining that the voice call is routed over the WWAN. In one example, the second sleep state may be a deep sleep state. In some examples, the second sleep state may comprises a state that reduces a power consumption of a modem during a duration associated with the voice call over the WWAN. The operation(s) at block 620 may be performed using the wireless communication manager 420 or 550 described with reference to FIG. 4 or 5, or the application processor sleep manager 450 described with reference to FIG. 4.

Thus, the method 600 may provide for wireless communication. It should be noted that the method 600 is just one implementation and that the operations of the method 600 may be rearranged or otherwise modified such that other implementations are possible. When the voice call processed by the modem is handed over multiple times, the method 600 may be repeated for each handover.

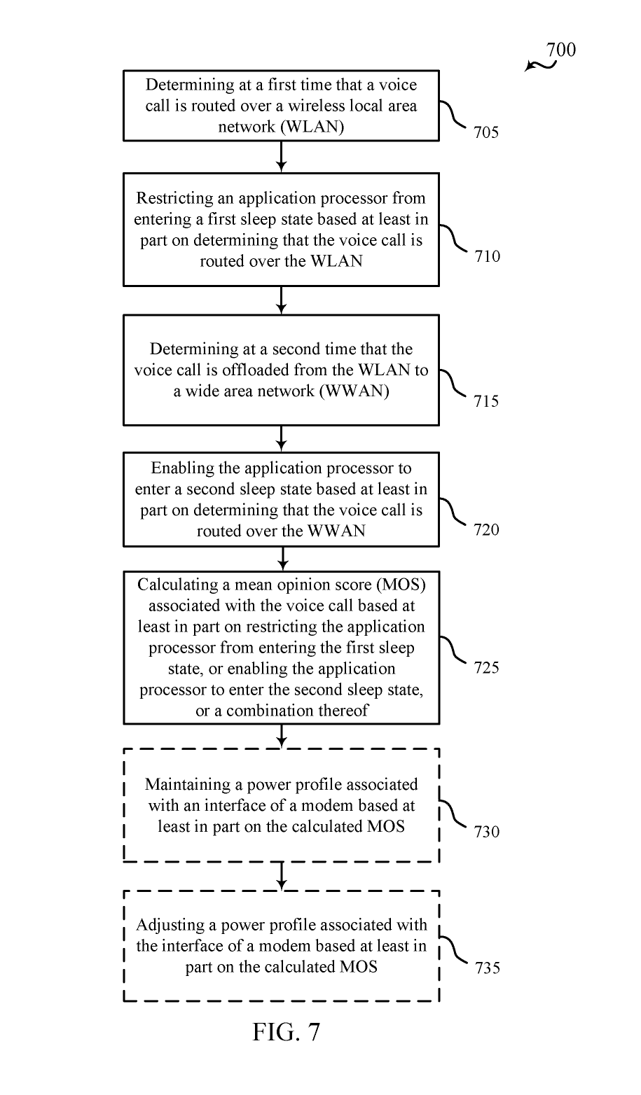

FIG. 7 is a flow chart illustrating an example of a method 700 for wireless communication, in accordance with various aspects of the present disclosure. For clarity, the method 700 is described below with reference to aspects of one or more of the UE 115, 215, or 515 described with reference to FIG. 1, 2, or 5, or aspects of the apparatus 315 or 415 described with reference to FIG. 3 or 4. In some examples, a UE may execute one or more sets of codes to control the functional elements of the UE to perform the functions described below. Additionally or alternatively, the UE may perform one or more of the functions described below using special-purpose hardware.

At block 705, the method 700 may include determining at a first time that a voice call is routed over a WLAN. In some examples, a voice call routed over a WLAN may include a WFC call. In some examples, determining at the first time that the voice call is routed over a WLAN may occur during (or as part of) an IMS call setup procedure in which an application processor that processes voice call traffic routed over the WLAN participates when initiating the voice call. Alternatively, in some examples, determining at the first time that the voice call is routed over a WLAN may occur when a UE participates in a handover of the voice call, such as a handover from routing the voice call over a WWAN to routing the voice call over the WLAN. The operation(s) at block 705 may be performed using the wireless communication manager 420 or 520 described with reference to FIG. 4 or 5, or the call routing determiner 445 described with reference to FIG. 4.

At block 710, the method 700 may include restricting an application processor from entering a first sleep state based at least in part on determining that the voice call is routed over the WLAN. In one example, the first sleep state may be a light sleep state. In some examples, the first sleep state may include a state that reduces a power consumption of a modem based at least in part on a packet exchange associated with the voice call over the WLAN. An application processor of a UE, for example, may enter a first, lighter sleep state, at times, when the voice call processed by a modem of the UE is routed over the WLAN. The operation(s) at block 710 may be performed using the wireless communication manager 420 or 550 described with reference to FIG. 4 or 5, or the application processor sleep manager 450 described with reference to FIG. 4.

At block 715, the method 700 may include determining at a second time that the voice call is offloaded from the WLAN to a WWAN. In some examples, a voice call routed over the WWAN may include a VoLTE call, a LTE/LTE-A call, a 3G call, or a 2G call. In some examples, determining at the second time that the voice call is routed over a WWAN may occur during (or as part of) an IMS call setup procedure in which an application processor that processes voice call traffic routed over the WWAN participates when initiating the voice call. Alternatively, in some examples, determining at the second time that the voice call is routed over a WWAN may occur when a UE participates in a handover of the voice call, such as a handover from routing the voice call over a WLAN to routing the voice call over the WWAN. The operation(s) at block 715 may be performed using the wireless communication manager 420 or 550 described with reference to FIG. 4 or 5, or the application processor sleep manager 450 described with reference to FIG. 4.

At block 720, the method 700 may include enabling the application processor to enter a second sleep state based at least in part on determining that the voice call is routed over the WWAN. In one example, the second sleep state may be a deep sleep state. In some examples, the second sleep state may comprises a state that reduces a power consumption of a modem during a duration associated with the voice call over the WWAN. The operation(s) at block 720 may be performed using the wireless communication manager 420 or 550 described with reference to FIG. 4 or 5, or the application processor sleep manager 450 described with reference to FIG. 4.

At block 725, the method 700 may calculate a MOS associated with the voice call based at least in part on restricting the application processor from entering the first sleep state, or enabling the application processor to enter the second sleep state, or a combination thereof. In some examples, a MOS may be calculated when an application processor associated with a UE is restricted from entering a first sleep state (e.g., when the voice call processed by the modem is routed over the WLAN). Alternatively, a MOS may be calculated when the application processor associated with the UE is enabled to enter a second sleep state (e.g., when the voice call processed by the modem is routed over the WWAN). The operation(s) at block 725 may be performed using the wireless communication manager 420 or 550 described with reference to FIG. 4 or 5, or the MOS calculator 455 described with reference to FIG. 4

At block 730, the method 700 may optionally include maintain a power profile associated with an interface of a modem based at least in part on the calculated MOS. In one example, a power profile may be maintained based at least in part on whether the voice call is routed over a WWAN interface or a WLAN interface. In some examples, a power profile of the WWAN interface or the WLAN interface may be maintained based at least in part on the calculated MOS matching a MOS calculated earlier in time (or based at least in part on the calculated MOS differing from the earlier-calculated MOS by more than a threshold difference). The operation(s) at block 730 may be performed using the wireless communication manager 420 or 550 described with reference to FIG. 4 or 5, or the modem interface power manager 460 described with reference to FIG. 4.

At block 735, the method 700 may optionally include adjusting a power profile associated with an interface of a modem based at least in part on the calculated MOS. In some examples, a power profile may be adjusted based at least in part on comparing a calculated MOS to a predetermined threshold MOS. Additionally or alternatively, in some examples, a power profile of the WWAN interface or the WLAN interface may be adjusted based at least in part on the calculated MOS differing from a MOS calculated earlier in time (or based at least in part on the calculated MOS differing from the earlier-calculated MOS by more than a threshold difference). The operation(s) at block 735 may be performed using the wireless communication manager 420 or 550 described with reference to FIG. 4 or 5, or the modem interface power manager 460 described with reference to FIG. 4.

Thus, the method 700 may provide for wireless communication. It should be noted that the method 700 is just one implementation and that the operations of the method 700 may be rearranged or otherwise modified such that other implementations are possible. When the voice call processed by the modem is handed over multiple times, the method 700 may be repeated for each handover.

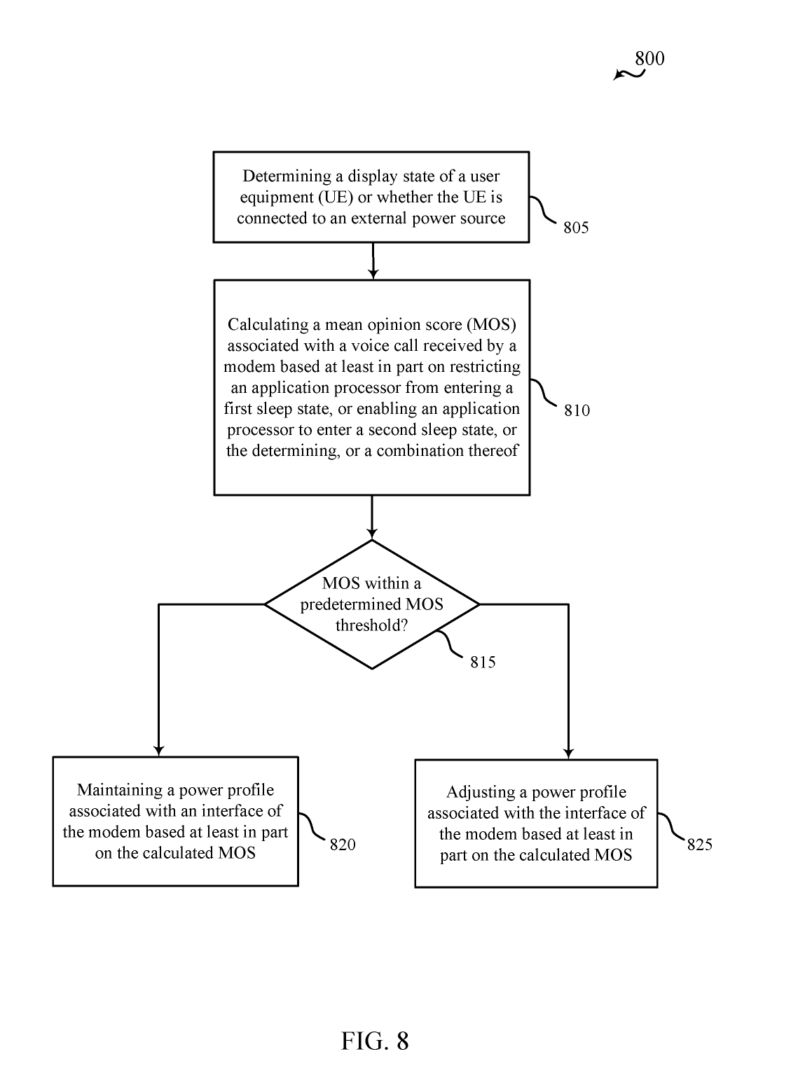

FIG. 8 is a flow chart illustrating an example of a method 800 for wireless communication, in accordance with various aspects of the present disclosure. For clarity, the method 800 is described below with reference to aspects of one or more of the UE 115, 215, or 515 described with reference to FIG. 1, 2, or 5, or aspects of the apparatus 315 or 415 described with reference to FIG. 3 or 4. In some examples, a UE may execute one or more sets of codes to control the functional elements of the UE to perform the functions described below. Additionally or alternatively, the UE may perform one or more of the functions described below using special-purpose hardware.

At block 805, the method 800 may determine a display state of a UE or whether the UE is connected to an external power source. In some examples, a display state may include an OFF state (i.e., display interface turned OFF). An external power source, in some examples, may include the UE being connected to a power source via a universal serial bus (USB) cable. The operation(s) at block 805 may be performed using the wireless communication manager 420 or 550 described with reference to FIG. 4 or 5.

At block 810, the method 800 may calculate a MOS associated with a voice call received by a modem based at least in part on restricting an application processor from entering a first sleep state, or enabling the application processor to enter a second sleep state, or the determining a display state of a UE or whether the UE is connected to an external power source, or a combination thereof. In some examples, a MOS may be calculated when an application processor associated with a UE is restricted from entering a first sleep state (e.g., when the voice call processed by the modem is routed over the WLAN). Alternatively, a MOS may be calculated when the application processor associated with the UE is enabled to enter a second sleep state (e.g., when the voice call processed by the modem is routed over the WWAN). In some examples, the MOS may be calculated based at least in part on the display state and a routing of a voice call, e.g., voice call routing over a WLAN or a WWAN. The operation(s) at block 810 may be performed using the wireless communication manager 420 or 550 described with reference to FIG. 4 or 5, or the MOS calculator 455 described with reference to FIG. 4.

At block 815, the method 800 may include determining whether the calculated MOS is within a predetermined MOS threshold. In some examples, a predetermined MOS threshold may be defined by a system administrator. In other examples, the predetermined MOS may be adaptively updated based at least in part on comparing a current calculated MOS and a previously calculated MOS, i.e., earlier in time. For example, the predetermined MOS threshold may be updated based at least in part on determining that a present calculated MOS is below the predetermined MOS threshold. The operation(s) at block 815 may be performed using the wireless communication manager 420 or 550 described with reference to FIG. 4 or 5, or the MOS calculator 455 described with reference to FIG. 4.

At block 820, the method 800 may maintain a power profile associated with an interface of the modem based at least in part on the calculated MOS. The operation(s) at block 820 may be performed using the wireless communication manager 420 or 550 described with reference to FIG. 4 or 5, or the modem interface power manager 460 described with reference to FIG. 4.

At block 825, the method 800 may adjust a power profile associated with the interface of the modem based at least in part on the calculated MOS. For example, the power profile of a WWAN interface or a WLAN interface may be adjusted based at least in part on the calculated MOS differing from a MOS calculated earlier in time (or based at least in part on the calculated MOS differing from the earlier-calculated MOS by more than a threshold difference). The operation(s) at block 825 may be performed using the wireless communication manager 420 or 550 described with reference to FIG. 4 or 5, or the modem interface power manager 460 described with reference to FIG. 4.

Thus, the method 800 may provide for wireless communication. It should be noted that the method 800 is just one implementation and that the operations of the method 700 may be rearranged or otherwise modified such that other implementations are possible. When the voice call processed by the modem is handed over multiple times, the method 700 may be repeated for each handover.

In some examples, aspects of the method 600, 700, or 800 described with reference to FIG. 6, 7, or 8 may be combined, omitted, or otherwise modified.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A may be referred to as CDMA2000 1×, 1×, etc. IS-856 (TIA-856) may be referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-A are new releases of UMTS that use E-UTRA. UTRA, E-UTRA, UMTS, LTE, LTE-A, and GSM are described in documents from an organization named 3GPP. CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such example.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Components implementing functions may also be physically located at various positions, including being distributed such that portions of functions are implemented at different physical locations. As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel techniques disclosed herein.

What is claimed is:

1. A method for wireless communication, comprising:
determining at a first time that a voice call is routed over a wireless local area network (WLAN);
restricting an application processor from entering a first sleep state based at least in part on determining that the voice call is routed over the WLAN;
determining at a second time that the voice call is offloaded from the WLAN to a wireless wide area network (WWAN); and
enabling the application processor to enter a second sleep state based at least in part on determining that the voice call is routed over the WWAN.

2. The method of claim 1, wherein the first time occurs before the second time.

3. The method of claim 1, further comprising:
calculating a mean opinion score (MOS) associated with the voice call received by a modem based at least in part on restricting the application processor from entering the first sleep state, or enabling the application processor to enter the second sleep state, or a combination thereof.

4. The method of claim 3, further comprising:
maintaining a power profile associated with an interface of the modem based at least in part on the calculated MOS.

5. The method of claim 3, further comprising:
adjusting a power profile associated with an interface of the modem based at least in part on the calculated MOS.

6. The method of claim 5, wherein the interface comprises a WWAN interface or a WLAN interface.

7. The method of claim 3, further comprising:
determining a display state of a user equipment (UE),
wherein calculating the MOS associated with the voice call is based at least in part on determining the display state.

8. The method of claim 3, further comprising:
determining whether a UE is connected to an external power source,
wherein calculating the MOS associated with the voice call is based at least in part on determining the UE is connected to the external power source.

9. The method of claim 1, wherein the first sleep state is the same as the second sleep state.

10. The method of claim 1, wherein the first sleep state comprises a state that reduces a power consumption of a modem based at least in part on a packet exchange associated with the voice call over the WLAN.

11. The method of claim 1, wherein the second sleep state comprises a state that reduces a power consumption of a modem during a duration associated with the voice call over the WWAN.

12. The method of claim 1, further comprising:
identifying a location of a UE associated with the voice call,
wherein determining that the voice call received by a modem is routed over the WLAN or the WWAN is based at least in part on the identification.

13. An apparatus for wireless communication, comprising:
a processor; and
memory in electronic communication with the processor;
the processor and the memory configured to:
determine at a first time that a voice call is routed over a wireless local area network (WLAN);
restrict an application processor from entering a first sleep state based at least in part on determining that the voice call is routed over the WLAN;
determine at a second time that the voice call is offloaded from the WLAN to a wireless wide area network (WWAN); and
enable the application processor to enter a second sleep state based at least in part on determining that the voice call is routed over the WWAN.

14. The apparatus of claim 13, wherein the first time occurs before the second time.

15. The apparatus of claim 13, wherein the processor and memory are configured to:
calculate a mean opinion score (MOS) associated with the voice call received by a modem based at least in part on restricting the application processor from entering the first sleep state, or enabling the application processor to enter the second sleep state, or a combination thereof.

16. The apparatus of claim 15, wherein the processor and memory are configured to:
maintain a power profile associated with an interface of the modem based at least in part on the calculated MOS.

17. The apparatus of claim 15, wherein the processor and memory are configured to:
adjust a power profile associated with an interface of the modem based at least in part on the calculated MOS.

18. The apparatus of claim 13, wherein the first sleep state comprises a state that reduces a power consumption of a modem based at least in part on a packet exchange associated with the voice call over the WLAN.

19. The apparatus of claim 13, wherein the second sleep state comprises a state that reduces a power consumption of a modem during a duration associated with the voice call over the WWAN.

20. An apparatus for wireless communication, comprising:
means for determining at first time that a voice call is routed over a wireless local area network (WLAN);
means for restricting an application processor from entering a first sleep state based at least in part on determining that the voice call is routed over the WLAN;
means for determining at a second time that the voice call is offloaded from the WLAN to a wireless wide area network (WWAN); and
means for enabling the application processor to enter a second sleep state based at least in part on determining that the voice call is routed over the WWAN.
